(19) United States
(12) Patent Application Publication
(10) Pub. No.: US 2017/0343828 A1
(43) Pub. Date: Nov. 30, 2017

(54) 3D POOL SYSTEM

(71) Applicant: BESTWAY INFLATABLES & MATERIAL CORP., Shanghai (CN)

(72) Inventor: Feng LIU, Shanghai (CN)

(21) Appl. No.: 15/596,727

(22) Filed: May 16, 2017

(30) Foreign Application Priority Data
May 27, 2016 (CN) 201620497941.5

(51) Int. Cl. G02B 27/22; E04H 4/14

(52) U.S. Cl. CPC G02B 27/2242; E04H 4/148

(57) ABSTRACT

The disclosure aims at providing a 3D pool system for enabling users to see 3D visual effects when is use and enhancing user experience. The 3D pool system may include a pool body and a viewing device. Pool body may include an inner pool surface provided with a pattern may include first regions and second regions. First regions and second regions respectively have first boundaries and second boundaries. First regions surrounded by first boundaries are filled with a first colour, and second regions surrounded by second boundaries are filled with a second colour. Viewing device is used for viewing pattern and refracting incident light from pattern, and re is a difference in depth of field between first regions 4a and second regions 4b of pattern, thereby creating a 3D effect. The disclosure realizes a three-dimensional effect of pattern on inner pool surface at low costs.

### TECHNICAL FIELD

The disclosure relates to the field of entertainment facilities, and more particularly to a 3D pool system.

### BACKGROUND

Above ground pools are entertainment products that a user would assemble and use on outdoor lawns or open ground, and mainly include supported pools, inflatable pools, etc. Because of their easy installation and low prices, the above ground pools are favoured by many consumers. In order to make the pools more pleasant to the eyes, patterns of water ripples, marble texture, mosaic, or children's favourite underwater world scenes are usually printed on the inner surfaces of the above ground pools; however, such patterns usually present a two-dimensional visual effect and cannot reproduce a real scene.

### SUMMARY

The disclosure can provide a 3D pool system for enabling users to obtain 3D visual effect when in use and enhancing the user experience.

According to the present disclosure, the 3D pool system for realizing the purpose may include a pool body and a viewing device. The pool body may include an inner pool surface provided with a pattern, and the pattern may include first regions and second regions. The first regions and the second regions respectively have first boundaries and second boundaries. The first regions surrounded by the first boundaries are filled with a first colour, and the second regions surrounded by the second boundaries are filled with a second colour. The viewing device may include goggles having first lenses, and second lenses for enhancing the light refraction, the second lens being attached to a surface of the first lens or being provided inside the first lens. The viewing device is used for viewing the pattern and refracting the incident light from the pattern, and there is a difference in depth of field between the first regions 4a and the second regions 4b of the pattern, thereby creating a 3D effect.

According to another aspect of the present disclosure, the pattern may include a background region for the first regions and the second regions. Moreover, The area of the background region mat be larger than the area of the first regions and the area of the second regions respectively. Also, the colours of the background region and the first and second boundaries are dark or light respectively.

According to another aspect of the present disclosure, the area of the background region is between 25% and 75% of the area of the pattern. Furthermore, the first colour and the second colour are complementary colours.

According to another aspect of the present disclosure, each of the first regions and the second regions may include an underlying pattern layer and a misaligned pattern layer which is overlaid on the underlying pattern layer in a misaligned manner.

According to another aspect of the present disclosure, the inner pool surface may include a pool side wall and a pool bottom. The pattern on the pool side wall can be expanded into a plane and thus a head end and a tail end are formed at an initial split position of the pattern, and the head end and the tail end can be joined to each other seamlessly. In additional, the pattern is printed directly on the inner pool surface, or a removable pattern carrier is provided on the inner pool surface, with the pattern printed on the pattern carrier.

The above-mentioned and features of the disclosure will be positive for producing the three-dimensional effect on the inner pool surface using the pattern having the distinction of colour depth, and the viewing device having the transparent or substantially transparent lens to view the pattern for improving the experience of the user when using the pool, in a relatively simple way at low costs.

### BRIEF DESCRIPTION OF THE DRAWINGS

The above-mentioned and other features, properties and advantages of the disclosure will become more apparent from the following description in conjunction with the accompanying drawings and the embodiments, in which:

FIG. 1 is a schematic view of a 3D pool system according to the disclosure.

FIG. 2 is a top view of a pool body according to the disclosure.

FIG. 3 is a schematic view of a pattern on a pool side wall according to the disclosure.

FIG. 4 is a schematic view of misaligned printing of the pattern on the pool side wall according to the disclosure.

FIG. 5 is a schematic view of a polariser positioned inside a lens according to the disclosure.

FIG. 6 is a schematic view of a polariser positioned on a surface of the lens according to the disclosure.

### DETAILED DESCRIPTION

The present disclosure will be further described hereinafter with reference to particular embodiments and the accompanying drawings. In the following description, more details are set forth in order to facilitate thorough understanding of the disclosure. However, it is obvious that the disclosure can be implemented in ways other than those as stated in this description. Those skilled in the art can make similar generalization and deduction according to the actual application situations without departing from the connotation of the disclosure. Therefore the scope of protection of the disclosure should not be limited to the content of these particular embodiments.

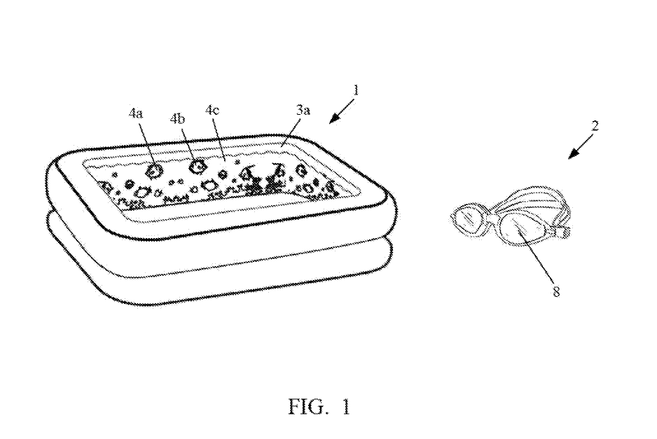

It is to be noted that FIGS. 1 to 5 are merely examples, which are not drawn to scale, and should not be construed as limiting the scope of protection actually claimed by the disclosure.

As shown in FIG. 1, the 3D pool system may include a pool body 1 and a viewing device 2.

The pool body 1 may include an inner pool surface provided with a pattern, and the pattern may include first regions 4a and second regions 4b; the first regions 4a and the second regions 4b respectively have first boundaries and second boundaries. The first regions 4a surrounded by the first boundaries are filled with a first colour, and the second regions 4b surrounded by the second boundaries are filled with a second colour.

The viewing device 2 is used for viewing the pattern and refracting the incident light from the pattern, thereby creating a 3D effect.

Preferably, the first region 4a and the second region 4b can be different regions of the same object in the pattern, such as different parts on the same coloured fish shape. There will be a difference in the depth of field between the different parts, and thus the coloured fish graphic can present a 3D effect. The first and second regions can also be different regions of different objects in the pattern, such as regions respectively contained in two fish shapes. There will be a difference in the depth of field between the two fish shapes, and human eyes will have a sense that one of the fish shapes is closer than the other, thus the 3D effect is produced.

Further, the pattern provided on the inner pool surface may include a background region 4c for the first regions 4a and the second regions 4b. The area of the background region 4c is larger than the area of the first regions 4a and the area of the second regions 4b respectively. The colours of the background region 4c and the first and second boundaries are dark or light respectively.

In the industry, the type or the depth of colour is typically classified by an RGB colour table. In the RGB colour table, the RGB values of black are (0, 0, 0), and the RGB values of white are (255, 255, 255). That is to say, the greater the sum of the RGB values (the three numbers in the parentheses) of a colour is, the lighter the colour is, and versa vice. Dark colours include colours with a sum of RGB values of less than 165, such as black and dark blue; and light colours include colours with a sum of RGB values of greater than 600, such as white and light grey.

The background region 4c serves to highlight the difference in colour between the first regions 4a and the second regions 4b. The dark colour is preferably black, because black can better absorb the light in the peripheral regions of the first regions 4a and the second regions 4b, so that only the colours of the first regions 4a and the second regions 4b on the pattern are presented, and thus a better 3D effect can be produced when the first regions 4a and the second regions 4b present different depth of field. The light colour is preferably white. Preferably, the area of the background region 4c is between 25% and 75% of the area of the pattern, so that the visual effect resulted from the difference in the depth of field between the first regions 4a and the second regions 4b is enhanced, facilitating formation of the 3D effect in the brains of the viewers.

Preferably, the first colour and the second colour are complementary colours, such as red and green, blue and orange, violet and yellow. Complementary colours can be selected in a colour circle. This is because complementary colours have a stronger contrast, and it is easier for the human eyes to capture the difference in the depth of field between complementary colours when viewing, and thus the 3D effect is easier to be produced.

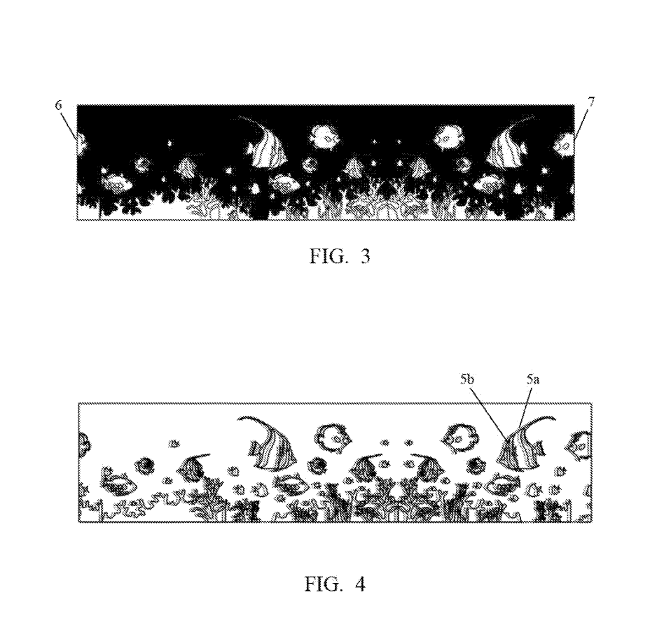

Further, as shown in FIG. 4, the pattern may include an underlying pattern layer 5a and a misaligned pattern layer 5b which is overlaid on the underlying pattern layer 5a in a misaligned manner. The patterns superimposed in a misaligned manner can also produce a 3D effect when viewed through the viewing device 2.

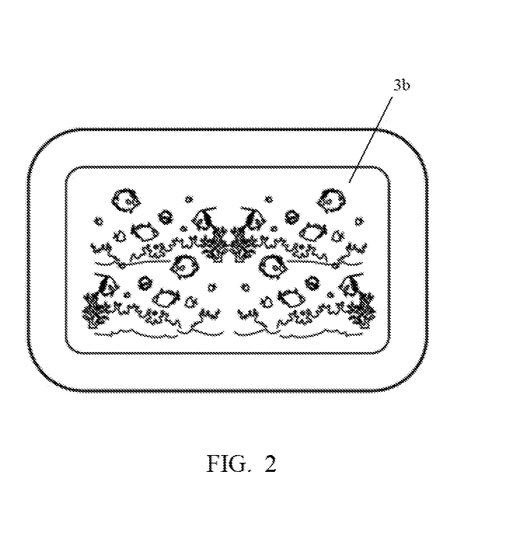

As shown in FIGS. 1 and 2, the inner pool surface may include a pool side wall 3a and a pool bottom 3b.

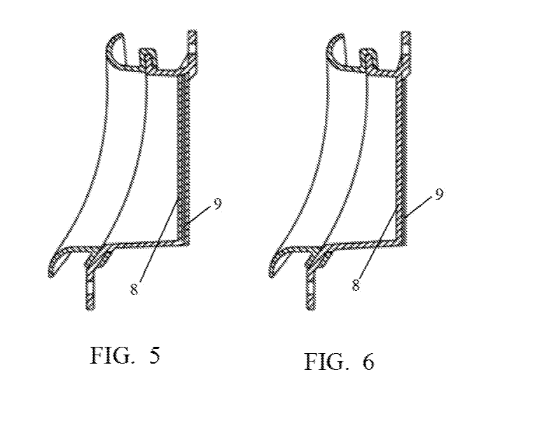

As shown in FIG. 5, the pattern on the pool side wall 3a can be expanded into a plane and thus a head end 6 and a tail end 7 are formed at an initial split position of the pattern, and the head end 6 and the tail end 7 can be joined to each other seamlessly. Such a design can achieve an integral three-dimensional sense without affecting by the displacement of layers.

Further, the pattern is printed directly on the inner pool surface, or a removable pattern carrier is provided on the inner pool surface, with the pattern printed on the pattern carrier. Such a design facilitates retrofitting of an existing pool into a 3D pool system, including installing a 3D pool system in a pool without a 3D system, as well as replacing the 3D display content of a pool having a 3D pool system.

Preferably, the viewing device 2 is a pair of goggles. The goggles can include first lenses 8 and second lenses 9 for enhancing the refraction of the light. The second lens 9 including the polariser can be attached to a surface of the first lens 8. Another embodiment of the disclosure can be a combination configuration including the second lens 9 emended inside with the first lens 8 through a method of hot-melt injection moulding.

The viewing device 2, ie. goggles, is positioned under a LED luminous pen. The light beam illuminates the lens, for example, the light beam illuminates the left lens from which transmitted light streams deviates to right. In the same way, the light beam illuminates the right lens from which transmitted light streams deviates to left. In addition, while the goggles are placed with front side upwards and on a steel frame, edge structure of frame of the goggle can withstand the pressure of 490±2 N during 1 minute±5 seconds. And centre region of the goggle is hit by steel ball with diameter of 22 mm and weight of 44 g falling from a height of 90 cm, and the surface of the lens is without crack or shatter. In addition, the goggle is immerged into water with a temperature of 23° C.±2° C., after 5 minutes, the goggle is taken out and then headband is stretched for simulating use for 30 seconds, and last the average displacement due to insertion of headband into side buckle is <5 mm.

The principle of the 3D pool system according to the disclosure is as follows: Light of different colours is refracted when passing through the first lens provided with the polariser. For example, in the case of red and blue light, the blue light is bent to a greater extent than the red light, resulting in a difference in the depth of field. When the human eyes receive the red and blue light bent through the first lenses, the red and blue light sources seen by the human eyes appear to have a front-rear positional relationship in space due to the difference in the depth of field. When the pattern printed on the inner pool surface by plane printing are differently coloured, a 3D effect is presented by viewing through the first lenses. When the background of the pattern is black, and the colour regions are separated with black lines, the 3D effect will be more obvious.

The positive progressive effects of the present disclosure lie in: by means of printing the pattern of different colours on the inner pool surface and viewing with the viewing device, the disclosure produces a three-dimensional effect of the pattern on the inner pool surface, and improves the experience of the user when using the pool, in a relatively simple way at low costs.

The present disclosure has been disclosed above in terms of the preferred embodiments which, however, are not intended to limit the present disclosure, and any person skilled in the art could make possible changes and alterations without departing from the spirit and scope of the present disclosure. Any amendment, equivalent change and modification made to the above embodiments according to the technical substance of the disclosure without departing from the contents of the technical solution of the disclosure fall within the scope of protection defined in the claims of the disclosure.

1. A 3D pool system, comprising a pool body and a viewing device;
the pool body comprising an inner pool surface, the inner pool surface comprising a pattern comprising a first region and a second region;
the first region and the second region respectively comprising a first boundary and a second boundary, the first region being surrounded by the first boundary filled with a first colour and the second region being surrounded by the second boundary filled with a second colour;
to the viewing device comprising a first lens, and second lens for enhancing the light refraction, the second lens being attached to a surface of the first lens; and
the viewing device being configured to view the pattern and refract an incident light from the pattern, a depth of field difference in a plurality of colour channels being between the first region and the second region of the pattern, thereby creating a 3D effect.

2. The 3D pool system according to claim 1, wherein the pattern comprises a background region for first regions and second regions, the area of the background region is greater than the area of the first regions and the area of the second regions respectively, and the colours of the background region and the first and second boundaries are dark or light respectively.

3. The 3D pool system according to claim 2, wherein the area of the background region is between 25% and 75% of the area of the pattern.

4. The 3D pool system according to claim 1, wherein the first colour and the second colour are complementary colours.

5. The 3D pool system according to claim 1, wherein each of the first region and the second region comprises an underlying pattern layer and a misaligned pattern layer and the misaligned pattern layer is overlaid on the underlying pattern layer in a misaligned manner.

6. The 3D pool system according to claim 1, wherein the inner pool surface comprises a pool side wall and a pool bottom.

7. The 3D pool system according to claim 6, wherein the pattern on the pool side wall is expanded into a plane, and the pattern comprises a split position to form a head end and a tail end

8. The 3D pool system according to claim 7, wherein the head end and the tail end are joined by a seamless method.

9. The 3D pool system according to claim 1, wherein the pattern is printed directly on the inner pool surface, or a removable pattern carrier is disposed on the inner pool surface, with the pattern printed on the pattern carrier.

10. The 3D pool system according to claim 1, wherein the second lens is disposed inside between at least two first lenses.
